(19) United States
(12) Patent Application Publication
(10) Pub. No.: US 2015/0165623 A1
(43) Pub. Date: Jun. 18, 2015

(54) Method For Programming An Industrial Robot In A Virtual Environment

(71) Applicant: Fredrik Kange, Sundbyberg (SE)

(72) Inventor: Fredrik Kange, Sundbyberg (SE)

(21) Appl. No.: 14/414,647

(22) PCT Filed: Jul. 13, 2012
(86) PCT No.: PCT/EP2012/063823

§ 371 Date: Jan. 13, 2015

(51) Int. Cl. B25J 9/16; G06F 17/50

(52) U.S. Cl. CPC B25J 9/163; G06F 17/50

(57) ABSTRACT

For programming an industrial robot to work on a workpiece, the robot is provided with a vision system capable of extracting a point cloud from the workpiece. A point cloud is extracted from the workpiece and turned into a workpiece model including at least one surface. Interaction of the robot with the workpiece is prescribed in a virtual environment including the workpiece model. A robot path is thereby obtained.

### FIELD OF THE INVENTION

The present invention relates to a method for programming an industrial robot to work on a workpiece.

### BACKGROUND OF THE INVENTION

There are two frequent programming tasks when teaching a robot comprising a vision system to work on a new workpiece: programming the vision system to recognize the workpiece and programming the robot to interact with the workpiece. For the vision system to recognize the workpiece a recognition algorithm needs to be created. A basis for the recognition algorithm is typically a two dimensional (2D) projection consisting of pixels or a three dimensional (3D) point cloud representing the shape of the workpiece. The recognition algorithm is created by identifying characteristic shapes of the workpiece and defining tolerances within which pixels or points deduced from a potential workpiece need to fall in order to be recognized as a workpiece.

For programming a robot to interact with a workpiece the robot is typically either jogged in relation to a real workpiece, or the robot path is designed in a virtual environment in relation to a CAD model of the workpiece. For the latter purpose a CAD model of the workpiece needs to exist. In some cases the CAD model used for original design of the workpiece exists but in other cases these CAD models may not be available or be far too detailed and complex for the purpose of creating a robot path. In these cases there arises a need to create a CAD model primarily for the purpose of creating the robot path.

It is known e.g. from U.S. Pat. No. 6,246,468 to automatically generate a CAD model from a point cloud. Therefore, a CAD model for the purpose of designing a robot path can be generated according to U.S. Pat. No. 6,246,468 as long as there is an available vision system capable of extracting a point cloud from the workpiece. Vision systems in industrial robots are however conventionally only used for recognition of workpieces and not for the purpose of designing robot paths. There has therefore not existed a need to turn a point cloud generated by a vision system of an industrial robot into a CAD model. There are, however, great benefits in time and equipment to be gained if the same vision system of the industrial robot can be used for both the purpose of workpiece recognition and for the purpose of path design.

### SUMMARY OF THE INVENTION

One object of the invention is to provide an efficient method for programming an industrial robot to work on a workpiece.

This object is achieved by the method according to the invention.

The invention is based on the realization that a vision system of an industrial robot can be used not only for recognition of workpieces, but also for designing robot paths.

According to a first aspect of the invention, there is provided a method for programming an industrial robot to work on a workpiece, the robot comprising a vision system capable of extracting a point cloud from the workpiece. The method comprises the steps of: extracting a first point cloud from a first workpiece; turning the first point cloud into a first workpiece model comprising at least one surface; and prescribing interaction of the robot with the first workpiece in a virtual environment comprising the first workpiece model to thereby obtain a first robot path. By using a workpiece model obtained from a point cloud for designing a robot path, there is no need to create a synthetic CAD model for designing the robot path in a virtual environment.

According to one embodiment of the invention the method comprises the step of: using a training point cloud extracted from a workpiece for training the vision system to recognize the workpiece to thereby obtain a recognition algorithm. This measure provides the possibility to recognize coming workpieces.

According to one embodiment of the invention the method comprises the steps of: extracting a second point cloud from a second workpiece; and applying the recognition algorithm on the second point cloud. By this measure potential workpieces are recognized and a robot path can be applied on them.

According to one embodiment of the invention the method comprises the step of: applying the first robot path on the second workpiece. By applying the first robot path for other workpieces than the one being the basis for creating the first robot path, a single robot path suffices for processing several workpieces.

According to one embodiment of the invention the method comprises the step of: turning the second point cloud into a second workpiece model comprising at least one surface. This measure provides the possibility to create an individual robot path for the second workpiece in a virtual environment.

According to one embodiment of the invention the method comprises the step of: prescribing interaction of the robot and the second workpiece in a virtual environment comprising the second workpiece model to thereby obtain a second robot path. By obtaining the second robot path the operation of the robot may be better adapted to the individual character of the second workpiece when not all of the workpieces are identical.

According to one embodiment of the invention the method comprises the step of: obtaining the first or the second robot paths automatically on the basis of a rule or rules set to the interaction of the robot with the first or the second workpieces. By this measure manual input is avoided when adapting the operation of the robot to the individual characters of the workpieces when not all of the workpieces are identical.

According to one embodiment of the invention the method comprises the step of: spatially aligning the training point cloud and the first point cloud. When the data set used for training the vision system and obtaining the first robot path both share the same coordinate system base, the first robot path can be applied directly to an identified workpiece.

### BRIEF DESCRIPTION OF THE DRAWINGS

The invention will be explained in greater detail with reference to the accompanying drawings, wherein

FIG. 1 shows one embodiment of the invention with a first workpiece, and

FIG. 2 shows the same embodiment of the invention with a second workpiece.

### DETAILED DESCRIPTION OF THE INVENTION

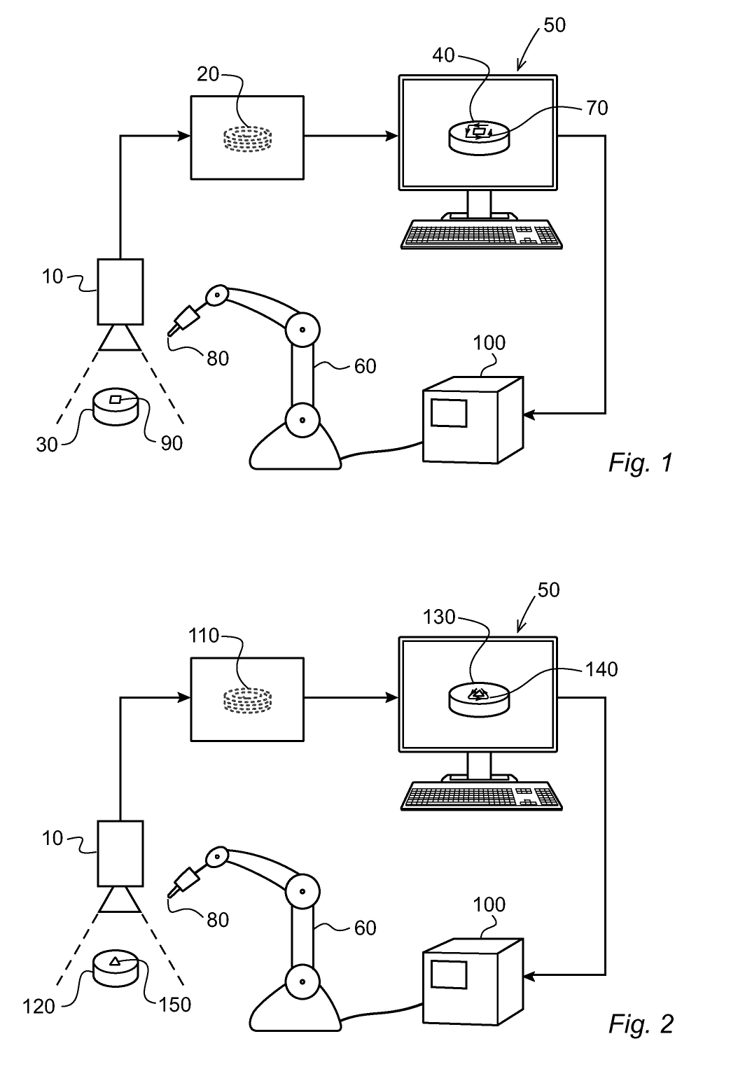

Referring to FIG. 1, a vision system 10 extracts a first point cloud 20 from a first workpiece 30, and the first point cloud 20 is further turned into a first workpiece model 40 that can be processed in a virtual environment 50. The first workpiece model 40 is a CAD model consisting of fully defined surfaces or of fully defined solid elements including surfaces. In the virtual environment 50 an interaction of the robot 60 with the first workpiece 30 can be prescribed for example by defining a first robot path 70 in relation to the first workpiece model 40 that a tool centre point (TCP) 80 of the robot 60 is to follow. In the example of FIG. 1 the robot 60 is to apply glue around a square opening 90 in a circular first workpiece 30. A first robot path 70, which can be transferred into a robot controller 100 for realizing the corresponding movement with a real robot 60, is thereby obtained. It is to be noted that even if the first robot path 70 of the present example comprises a plurality of interaction points with the first workpiece model 40, a single interaction point may also be considered as a robot path.

According to the present invention the vision system 10 is also used for its conventional purpose to recognize workpieces and their positions and orientations. To this end the vision system 10 needs to be trained to recognize workpieces, and the first point cloud 20 extracted from the first workpiece 30 can be used as a training point cloud for training the vision system 10. The training of the vision system 10 is done in a conventional manner, and a recognition algorithm is thereby obtained. It is to be noted that the same (first) point cloud 20 may be used both for obtaining the first robot path 70 and as the training point cloud for obtaining the recognition algorithm, but these point clouds do not necessarily need to be the same. In case the first point cloud 20 is different from the training point cloud, then one or both of the point clouds may be spatially adjusted, using a best-fit alignment, so as to coincide with one another. The calculated spatial adjustment ensures that the obtained first robot path 70 corresponds to the position and orientation provided by the recognition algorithm. Furthermore, the amount of required spatial adjustment could for example be calculated automatically by applying the recognition algorithm obtained from the training point cloud to locate the first point cloud 20. It should be noted that it is obvious to an individual knowledgeable in the technical field that the spatial adjustment described above could also be calculated by using the CAD surface representation of the first workpiece model 40, instead of the first point cloud 20 itself.

Once there is a recognition algorithm, it can be applied on further point clouds extracted from further potential workpieces. With reference to FIG. 2, the recognition algorithm can for example be applied on a second point cloud 110 extracted from a second workpiece 120. When the second workpiece 120 is recognized, the previously obtained first robot path 70 can be applied on the second workpiece 120 to achieve the same result as for the first workpiece 30. The coordinate system of the second workpiece 120 needs eventually be adjusted if the position and/or orientation of the second workpiece 120 are different from those of the first workpiece 30. Alternatively, the second point cloud 110 can be turned into a second workpiece model 130 in the same way as the first point cloud 20. An individual second robot path 140 can thereby be designed for the second workpiece 120 in the virtual environment 50. Designing individual robot paths for different workpieces may be desirable especially if the workpieces are not identical.

In some embodiments it is possible to automate the design of the first and second robot paths 70, 140, and any subsequent robot paths. The interaction of the robot 60 with the first workpiece 30 in the virtual environment 50 can be prescribed with certain flexibility by setting rules that make it possible to define a robot path without totally fixing the same. For example, the contour of the square opening 90 of FIG. 1 can be recognized with the vision system 10, and the dimensions of the same can be automatically determined. It can then be prescribed e.g. that the robot path shall follow a track with a 5 mm offset outside of the opening 90 despite of the actual shape and dimensions of the same. Consequently, the first robot path 70 will receive a square shape. However, when the same rule is applied on the second workpiece 120 with a triangular opening 150, the second robot path 140 will receive a triangular shape. By designing the robot paths automatically renders the system more flexible and is advantageous especially if the workpieces are not identical.

The invention is not limited to the embodiments shown above, but the person skilled in the art may modify them in a plurality of ways within the scope of the invention as defined by the claims. While the described embodiment lists a single robot and vision system, it is obvious to an individual knowledgeable in the technical field that the method and embodiment described above can be applied to systems where multiple robots may work on the same workpiece, the workpiece either being stationary or held by a robot. The vision system may also be stationary, or mounted on the robot(s).

1. A method for programming an industrial robot to work on a workpiece, the robot comprising a vision system capable of extracting a point cloud from the workpiece, the method comprising the steps of:
extracting a first point cloud from a first workpiece;
turning the first point cloud into a first workpiece model comprising at least one surface; and
prescribing interaction of the robot with the first workpiece in a virtual environment comprising the first workpiece model to thereby obtain a first robot path.

2. The method according to claim 1 comprising the step of:
using a training point cloud extracted from a workpiece for training the vision system to recognize the workpiece to thereby obtain a recognition algorithm.

3. The method according to claim 2 comprising the steps of:
extracting a second point cloud from a second workpiece; and
applying the recognition algorithm on the second point cloud.

4. The method according to claim 3 comprising the step of:
applying the first robot path on the second workpiece.

5. The method according to claim 3 comprising the step of:
turning the second point cloud into a second workpiece model comprising at least one surface.

6. The method according to claim 5 comprising the step of:
prescribing interaction of the robot and the second workpiece in a virtual environment comprising the second workpiece model to thereby obtain a second robot path.

7. The method according comprising the step of:
obtaining the first robot path automatically on the basis of a rule or rules set to the interaction of the robot with the first workpiece.

8. The method according to claim 6 comprising the step of:
obtaining the second robot path automatically on the basis of a rule or rules set to the interaction of the robot with the second workpiece.

9. The method according to claim 2, wherein the training point cloud is different from the first point cloud, comprising the step of:
spatially aligning the training point cloud and the first point cloud.
